(19) United States
(12) Patent Application Publication
(10) Pub. No.: US 2011/0157375 A1
(43) Pub. Date: Jun. 30, 2011

(54) DISPLAY DEVICE AND PROGRAM FOR DISPLAY DEVICE

(75) Inventor: Yoshihisa KUSUMOTO, Nagoya-shi (JP)

(73) Assignee: BROTHER KOGYO KABUSHIKI KAISHA, Nagoya-shi (JP)

(21) Appl. No.: 12/980,148

(22) Filed: Dec. 28, 2010

(30) Foreign Application Priority Data
Dec. 28, 2009 (JP) 2009-297224

(51) Int. Cl. H04N 5/225

(52) U.S. Cl. 348/207.1; 348/E05.024

(57) ABSTRACT

A display device has a data storage section with a transfer memory area and a storage memory area, and a display section to display the stored data. A first and second communication section establish communication with a first and second external device, respectively. A connection detecting section activates the second communication section when connection with the second external device is established. A storage determining section determines whether data is stored in the transfer memory area. A particular storage control section transfers the data from the transfer memory area to the storage memory area. A transfer control section transfers the particular data to a transfer memory area of the second external device, when the second communication section is active, and the particular data is present in the transfer memory area.

### CROSS-REFERENCE TO RELATED APPLICATIONS

The present application claims priority to and the benefit of Japanese Patent Application No. 2009-297224, which was filed on Dec. 28, 2009, the disclosure of which is incorporated herein by reference in its entirety.

### BACKGROUND OF THE INVENTION

1. Field of the Invention

The invention relates to display devices and programs for display devices.

2. Description of the Related Art

In a known personal computer and digital camera system, when the personal computer is connected to a digital camera, if data is stored in a transfer memory area of the personal computer in advance, the personal computer is configured to automatically transfer the data to the digital camera. When a user connects the personal computer to the digital camera, the data can be transferred to the digital camera without the need for the user to designate the data to be transferred. If the data is to be transferred from the personal computer to multiple digital cameras, a digital camera currently connected to the personal computer may simply be replaced with another digital camera.

However, when the user is performing the process of transferring the data from the personal computer to the multiple digital cameras, the same personal computer cannot be used by another user until the data transferring process is completed for all of the digital cameras.

### SUMMARY OF THE INVENTION

However, when the user is performing the process of transferring the data from the personal computer to the multiple digital cameras, the same personal computer cannot be used by another user until the data transferring process is completed for all of the digital cameras.

The invention thus provides a display device that can store data received from a first external device into a second external device without the need for the user to designate the data. By using this display device, the user can make the display device receive the data from the first external device and subsequently make the second external device store the data without using the first external device.

In an embodiment of the invention, a display device comprises a data storage section comprising a transfer memory area and a storage memory area, and configured to store data, a display section configured to display the data stored in the data storage section, a first communication section configured to establish communication with a first external device, a second communication section configured to establish communication with a second external device, a connection detecting section configured to activate the second communication section when the connection detecting section detects that a connection with the second external device via the second communication section is established, a storage determining section that determines whether a particular data is stored in the transfer memory area of the data storage section, a particular storage control section configured to transfer the particular data from the transfer memory area into the storage memory area, and a transfer control section configured to, when the storage determining section determines that the particular data is stored in the transfer memory area, to transfer the particular data to a transfer memory area of the second external device via the second communication section, when the second communication section is active.

In another embodiment of the invention, a computer program product stored on a non-transitory computer-readable medium, comprising instructions for causing a computer of a display device to execute the steps of determining whether a particular data is stored from a first external device in a transfer memory area of a data storage section, when the particular data is stored in the transfer memory area, storing the particular data into a storage memory area of the data storage section, detecting whether a connection with a second external device is established, determining whether the particular data is stored in the transfer memory area of the data storage section when the connection is detected as being established in the detecting step, and transferring, when the determining step determines that the particular data is stored in the transfer memory area, the particular data to a transfer memory area of the second external device, when the connection with the second external device is established.

Other objects, features, and advantages will be apparent to persons of ordinary skill in the art from the following detailed description of the invention and the accompanying drawings.

### BRIEF DESCRIPTION OF THE DRAWINGS

For a more complete understanding of the present invention, needs satisfied thereby, and the objects, features, and advantages thereof, reference now is made to the following description taken in connection with the accompanying drawings.

FIG. 1 is a schematic exterior view of a display device according to an embodiment of the invention.

FIG. 2 is a block diagram showing a hardware configuration of the display device according to an embodiment of the invention.

FIG. 3 illustrates the transition of the status of first to third display devices in a first operation procedure, according to an embodiment of the invention.

FIG. 4 illustrates the transition of the status of the first to third display devices in a second operation procedure, according to an embodiment of the invention.

FIG. 5 is a flow chart of main device processing, according to an embodiment of the invention.

FIG. 6 is a flow chart of USB-device connection processing, according to an embodiment of the invention.

FIG. 7 is a flow chart of USB-host connection processing, according to an embodiment of the invention.

FIG. 8 is a flow chart of menu processing, according to an embodiment of the invention.

FIG. 9 illustrates a communication sequence when a USB host connector of the first display device is connected to a USB device connector of the second display device, according to an embodiment of the invention.

### DETAILED DESCRIPTION OF EMBODIMENTS OF THE INVENTION

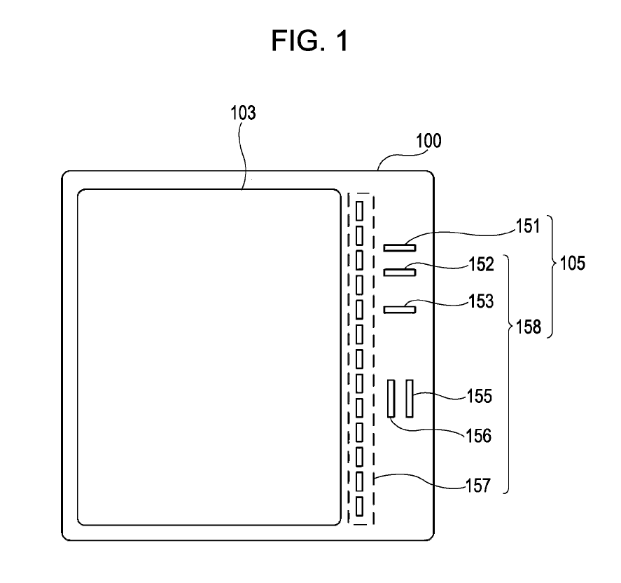

Embodiments of the present invention, and their features and advantages, may be understood by referring to FIGS. 1-9, like numerals being used for like corresponding parts in the various drawings.

FIG. 1 shows a display device 100 according to an embodiment of the invention. Display device 100 may comprise a nonvolatile display panel 103 and an operation section 105. The display device 100 may renew an image on the nonvolatile display panel 103 in accordance with an operation by a user. The nonvolatile display panel 103 may display various kinds of images, such as image contents in a data format displayable on the display device 100, a content selection screen, and a menu screen. Display device 100 may comprise a content selection screen (not shown). The content selection screen may display contents, which may be selected by a user for displaying on display device 100. The menu screen may be a screen used by the user for selecting a menu item executable with the display device 100. The contents displayable on the display device 100 may be constituted of multiple pages of images.

The nonvolatile display panel 103 may be a display panel equipped with an electrophoretic display element or cholesteric liquid-crystal. In the following description, the nonvolatile display panel 103 in this embodiment is a display panel equipped with an electrophoretic display element. In other embodiments of the invention, display panel 103 may be implemented using other materials and methods.

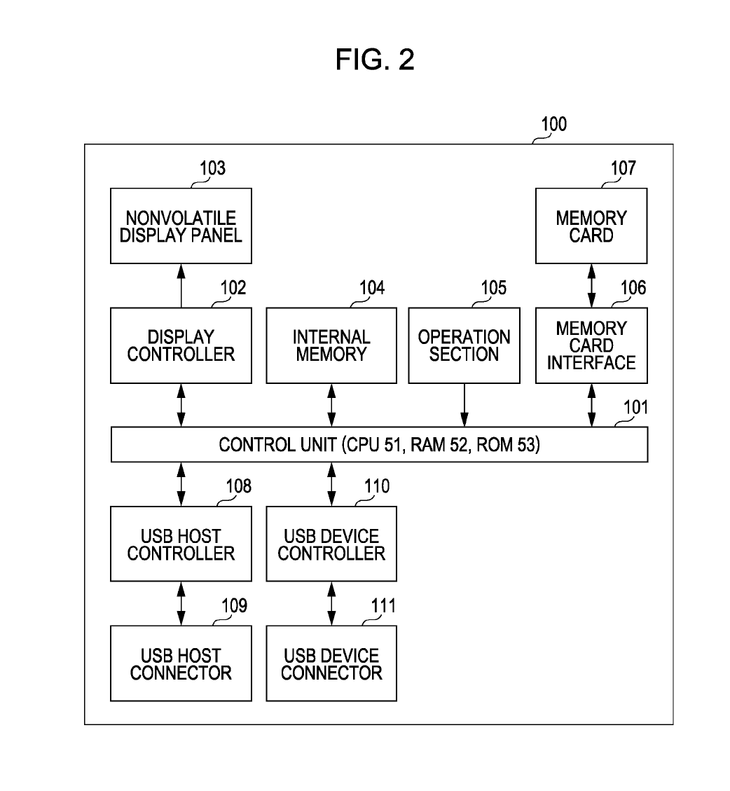

As shown in FIG. 2, an image on the nonvolatile display panel 103 may be renewed by a display controller 102, to be described in more detail herein. The image displayed on the nonvolatile display panel 103 may be maintained in the displayed state even when power supplied to the nonvolatile display panel 103 or the display controller 102 is removed. Because such a display device 100 may not require power to maintain an image displayed state, power consumption may be reduced by stopping the supply of power to the nonvolatile display panel 103 or the display controller 102 after renewing the image. Therefore, the display device 100 may consume less power as compared with display devices of the related art equipped with self-luminous display panels, such as LCD (liquid-crystal display) panels or PDPs (plasma display panels), which consume power when displaying an image. Although the display device 100 may be equipped with the nonvolatile display panel 103 in this embodiment, the invention is applicable to other embodiments including display devices equipped with display panels other than the nonvolatile display panel 103.

The operation section 105 may comprise a power key 151 to be pressed by the user when turning the power on or off, and a plurality of operation keys 158 to be used by the user for inputting predetermined commands while the display device 100 is turned on. In the display device 100, the operation keys 158 may comprise a menu key 152, a close key 153, a previous key 155, a next key 156, and thirteen selecting keys 157. The menu key 152 may be a key to be pressed by the user when, for example, displaying a menu screen, to be described later. The close key 153 may be a key to be pressed when, for example, closing a currently-displayed content image. The previous key 155 may be a key to be pressed when, for example, renewing the currently-displayed content image to an image in the previous page. The next key 156 may be a key to be pressed when, for example, renewing the currently-displayed content image to an image in the next page. The selecting keys 157 may be keys to be pressed when, for example, selecting menu items currently displayed on the menu screen.

FIG. 2 shows a hardware configuration of the display device 100 according to an embodiment of the invention. The display device 100 may comprise a control unit 101, the display controller 102, the nonvolatile display panel 103, an internal memory 104, the operation section 105, a memory card interface 106, a memory card 107, a USB host controller 108, a USB host connector 109, a USB device controller 110, and a USB device connector 111.

The control unit 101 may comprise a CPU 51, a RAM 52, and a ROM 53. The CPU 51, the RAM 52, and the ROM 53 may operate in cooperation with each other to execute various processing, to be described later, so that the control unit 101 can control peripheral devices of the display device 100. The CPU 51 may control the peripheral devices of the display device 100 in accordance with a program stored in the ROM 53. The RAM 52 may be a volatile storage unit that temporarily stores the program stored in the ROM 53 when the CPU 51 executes processing or data required when executing processing. The ROM 53 may be a nonvolatile storage unit that stores a program for, for example, main processing, to be described later. The display controller 102 may control the output of a gate signal from a gate driver of the nonvolatile display panel 103 and the output of a source signal from a source driver in accordance with an image renewal command received from the control unit 101. Thus, the display controller 102 may control the renewal of an image displayed on the nonvolatile display panel 103.

In an embodiment of the invention, the nonvolatile display panel 103 may comprise an electrophoretic display panel of a known active matrix type. The nonvolatile display panel 103 may comprise a gate driver (not shown) for outputting a gate signal to each gate line of the nonvolatile display panel 103 and a source driver (not shown) for outputting a source signal to each source line of the nonvolatile display panel 103. The nonvolatile display panel 103 may comprise a transparent substrate at the display-face side and a back substrate provided at a position facing the transparent substrate. An electrophoretic display element may be provided between the transparent substrate and the back substrate.

The internal memory 104 may be a nonvolatile storage section for storing, for example, setting information, to be described later. Specifically, in an embodiment of the invention, a NAND flash memory device, for example, may be used. As mentioned above, the operation section 105 may comprise the power key 151 and the plurality of operation keys 158. The operation section 105 may output a signal according to a pressed operation key 158 to the control unit 101. Thus, the control unit 101 can determine which one of the keys is operated by the user.

In accordance with a command from the control unit 101, the memory card interface 106 may read data from the memory card 107 loaded in the display device 100, write data into the memory card 107, and delete data stored in the memory card 107. The memory card 107 may be configured to store content data (e.g., a particular data) in a data format that is displayable on the display device 100 and data, in a predetermined file format, received from an external device. Furthermore, the memory card 107 may store a folder with a name “ABC” as a transfer memory area. This folder with the name “ABC” will be interchangeably referred to as “ABC folder” hereinafter. If data is stored in the ABC folder when the display device 100 is connected to an external device, such as another display device 100, the data stored in the ABC folder may be transferred to the connected external device in accordance with the setting, to be described later. Moreover, the memory card 107 also stores a folder with a name “ABC_A”. The folder with the name “ABC_A” will be interchangeably referred to as “ABC_A folder” hereinafter. If the user commands that no data is to be transferred in USB-host connection processing, to be described later, the data in the ABC folder may be saved in the ABC_A folder. The memory card 107 may be detachably provided in the display device 100.

The USB host controller 108 may control communication with a device-side external device connected via the USB host connector 109. The USB device controller 110 may control communication with a host-side external device connected via the USB device connector 111.

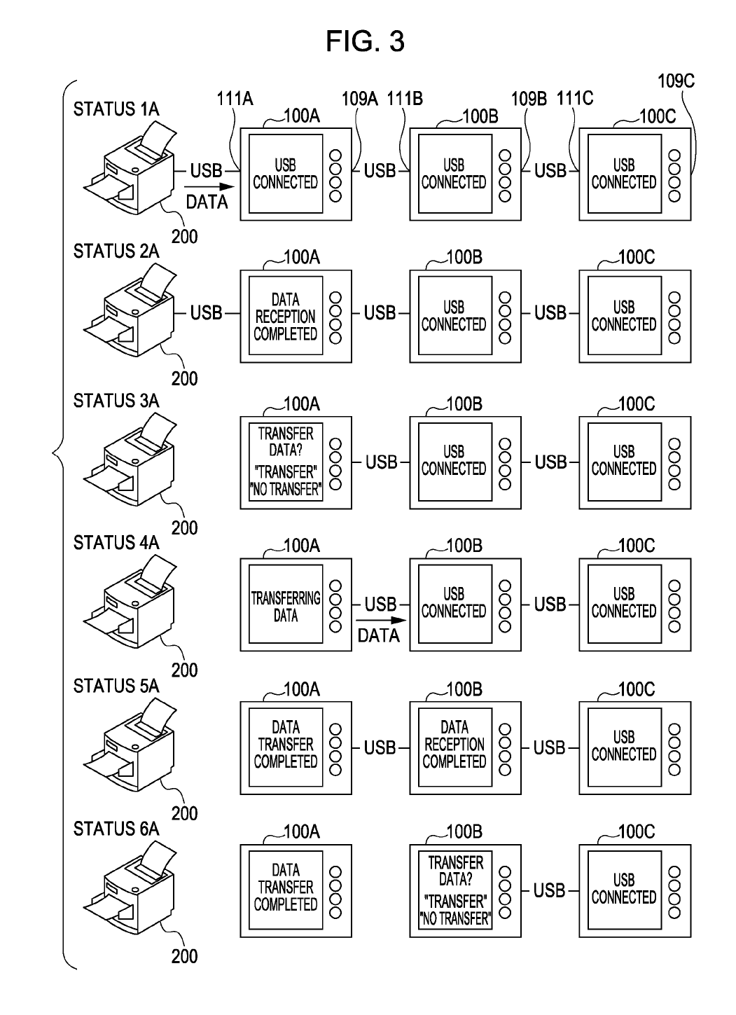

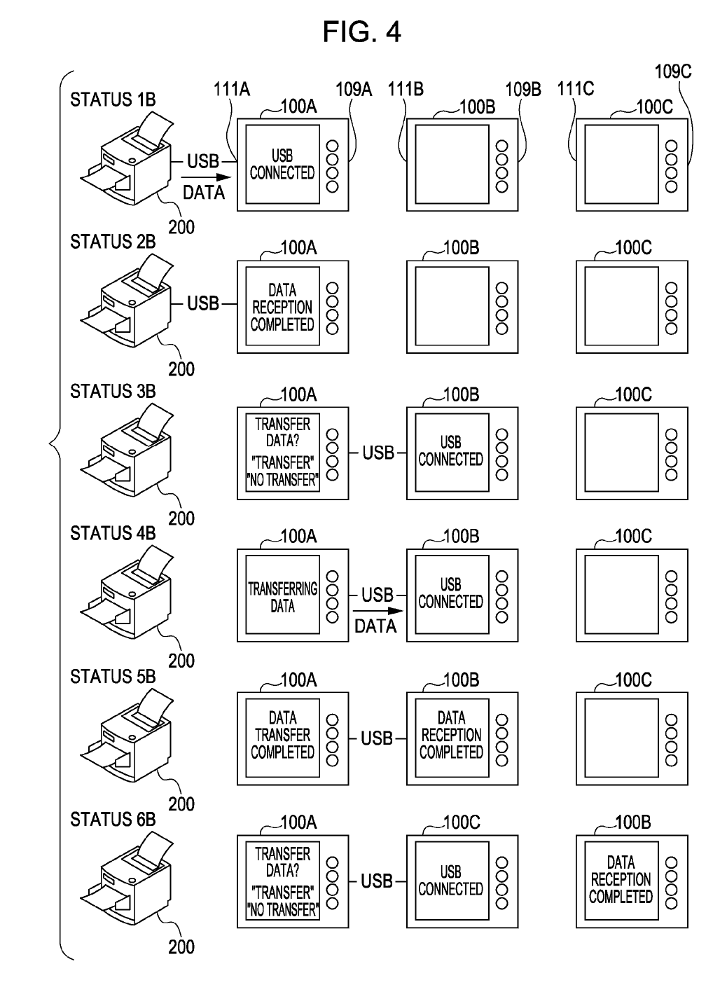

FIGS. 3 and 4 describe an example of transition of the status of three display devices 100 when transferring image data read by a multifunction device 200 to the display devices 100, according to an embodiment of the invention. In order to differentiate between the three display devices 100, the three display devices 100 will be respectively referred to as “display device 100A”, “display device 100B”, and “display device 100C” in the following description.

The multifunction device 200 may have a scanner function for scanning an original made of paper, reading an image on the original, and creating data in a predetermined file format, such as PDF, from the read image. Furthermore, the multifunction device 200 may comprise a USB host controller. When connected to an external device via the USB host controller using the USB mass storage device class, the multifunction device 200 has a function of transferring the image data, such as PDF data, read from the original to the external device. When transferring data to a device-side external device, the multifunction device 200 may create a folder with a name “ABC” in a storage section of the external device and stores the data into the ABC folder. If the ABC folder is preliminarily created in the storage section of the external device, the multifunction device 200 may store the data into the preliminarily created ABC folder. The multifunction device 200, the display device 100A, the display device 100B, and the display device 100C may be connected to each other via cables, e.g., USB cables.

FIG. 3 describes the transition of the status of the display devices 100A to 100C when transferring data to the display devices 100A to 100C in a first operation procedure. The user connects the USB host connector of the multifunction device 200 to a USB device connector 111A of the display device 100A by using a USB cable. The multifunction device 200 and the display device 100A may be connected to each other using the USB mass storage device class. When connection of the USB device connector 111A is detected, the display device 100A may display a USB-connected screen. The USB-connected screen is a screen that displays a message indicating that the USB device connector 111A of the display device 100A is connected with an external device.

Next, the user connects a USB host connector 109A of the display device 100A to a USB device connector 111B of the display device 100B by using a USB cable. The display device 100A and the display device 100B may be connected to each other using the USB mass storage device class. When connection of the USB device connector 111B is detected, the display device 100B may display a USB-connected screen. Subsequently, the user connects a USB host connector 109B of the display device 100B to a USE device connector 111C of the display device 100C by using a USB cable. The display device 100B and the display device 100C may be connected to each other using the USB mass storage device class. When connection of the USB device connector 111C is detected, the display device 100C may display a USB-connected screen.

After connecting the multifunction device 200, the display device 100A, the display device 100B, and the display device 100C via USB cables in this manner, the user operates the multifunction device 200 so as to make the multifunction device 200 read image data from the original made of paper. The multifunction device 200, having read the image data, may transfer the image data to the display device 100A via a cable, e.g., the USB cable. The status of the display devices 100A to 100C and the multifunction device 200 when the multifunction device 200 is transferring the data to the display device 100A in this manner is shown as “status 1A” in FIG. 3.

After the read data is entirely transferred to the display device 100A, the multifunction device 200 may send a completion notification to the display device 100A. A completion notification is a notification indicating that the data transfer is completed. When the display device 100A receives this completion notification, the display device 100A may store the received data and may display a data-reception-completed screen. A data-reception-completed screen is a screen that displays a message indicating that data reception is completed. The status of the display devices 100A to 100C and the multifunction device 200 when the display device 100A is displaying the data-reception-completed screen in this manner is shown as “status 2A” in FIG. 3.

Because data is not sent from the multifunction device 200 to the display device 100A after the data-reception-completed screen is displayed on the display device 100A, the user may disconnect the multifunction device 200 and the display device 100A from each other.

If the USB host connector 109A is connected to an external device after the data-reception-completed screen is displayed, the display device 100A may display a confirmation screen. A confirmation screen is a screen for inquiring the user about whether or not to permit data transfer. The status of the display devices 100A to 100C and the multifunction device 200 when the confirmation screen is displayed on the display device 100A after the USB cable between the multifunction device 200 and the display device 100A has been disconnected by the user is shown as “status 3A” in FIG. 3. Because the multifunction device 200 is not subsequently operated by the current user, the multifunction device 200 can be used by another user. This eliminates a problem where the multifunction device 200 is occupied by a single user until completion of data transfer to all of the display devices 100A to 100C.

After the display device 100A displays the confirmation screen, if the user performs an operation for permitting data transfer, the display device 100A may start transferring the data to the display device 1002 via the USB host connector 109A. In this case, the display device 100A may display a data-transferring screen. A data-transferring screen is a screen that displays a message for informing the user that data is being transferred. The status of the display devices 100A to 100C and the multifunction device 200 at this time is shown as “status 4A” in FIG. 3.

When the data transfer is completed by the display device 100A, the display device 100A may display a data-transfer-completed screen. A data-transfer-completed screen is a screen that displays a message indicating that data transfer is completed. Moreover, when the data transfer is completed, the display device 100A may send a completion notification to the display device 100B. The display device 100B having received the completion notification displays a data-reception-completed screen. Then, the display device 100B may store the data received from the display device 100A. The status of the display devices 100A to 100C and the multifunction device 200 at this time is shown as “status 5A” in FIG. 3.

After the completion of the data transfer from the display device 100A to the display device 100B, the user may disconnect the USB cable between the display device 100A and the display device 100B. Because, there is no need to maintain the connection between the display device 100A and the display device 100B using the USB cable. Alternatively, the user may disconnect all of the USB cables after the data transfer to all of the display devices 100A to 100C is completed. If the USB host connector 109B is connected to an external device after the data-reception-completed screen is displayed, the display device 100B may display a confirmation screen. The status of the display devices 100A to 100C and the multifunction device 200 at this time is shown as “status 6A” in FIG. 3.

Subsequently, when the user operates the display device 100B for permitting data transfer, the data is transferred from the display device 100B to the display device 100C so as to be stored in the display device 100C. With the display devices 100A to 100C according to an embodiment, the data received from the multifunction device 200 can be stored in the display devices 100A to 100C by simply connecting the display devices 100A to 100C without having to perform operation for designating the data received from the multifunction device 200.

The transition of the status of the display devices 100A to 100C when transferring data to the display devices 100A to 100C in a second operation procedure will be described below with reference to FIG. 4.

The user may connect the USB host connector of the multifunction device 200 to the USB device connector 111A of the display device 100A by using a USB cable. The multifunction device 200 and the display device 100A may be connected to each other using the USB mass storage device class. When connection of the USB device connector 111A is detected, the display device 100A may display the USB-connected screen. After connecting the multifunction device 200 and the display device 100A via the USB cable in this manner, the user may operate the multifunction device 200 so as to make the multifunction device 200 read image data from the original made of paper. The multifunction device 200, having read the image data, may transfer the image data to the display device 100A via the USB cable. The status of the display devices 100A to 100C and the multifunction device 200 when the multifunction device 200 is transferring the data to the display device 100A in this manner is shown as “status 1B” in FIG. 4. In this case, the display device 100B and the display device 100C are displaying a blank screen as an example.

After the read data is entirely transferred to the display device 100A, the multifunction device 200 may send a completion notification to the display device 100A. The display device 100A having received the completion notification may store the received data and may display the data-reception-completed screen. This data-reception-completed screen is a screen that displays a message indicating that data reception is completed. The status of the display devices 100A to 100C and the multifunction device 200 when the display device 100A is displaying the data-reception-completed screen in this manner is shown as “status 2B” in FIG. 4.

Because data is not sent from the multifunction device 200 to the display device 100A after the data-reception-completed screen is displayed on the display device 100A, the user may disconnect the multifunction device 200 and the display device 100A from each other. After the user disconnects the USB cable between the multifunction device 200 and the display device 100A, the multifunction device 200 may be used freely by another user. This eliminates the problem where the multifunction device 200 is occupied by a single user until completion of data transfer to all of the display devices 100A to 100C.

After the data-reception-completed screen is displayed, the user may connect the USB host connector 109A of the display device 100A to the USB device connector 111B of the display device 100B by using a USB cable. The display device 100A and the display device 100B may be connected to each other using the USB mass storage device class. When connection of the USB device connector 111B is detected, the display device 100B may display the USB-connected screen. When connection of the USB host connector 109A is detected, the display device 100A may display the confirmation screen. The status of the display devices 100A to 100C and the multifunction device 200 when the confirmation screen is displayed by the display device 100A after the user disconnects the USB cable between the multifunction device 200 and the display device 100A and then connects the USB cable between the display device 100A and the display device 100B is shown as “status 3B” in FIG. 4.

After the display device 100A displays the confirmation screen, if the user performs operation for permitting data transfer, the display device 100A may start transferring the data to the display device 100B via the USB host connector 109A. In this case, the display device 100A may display the data-transferring screen. The status of the display devices 10014 to 100C and the multifunction device 200 at this time is shown as “status 4B” in FIG. 4.

When the data transfer is completed by the display device 10014, the display device 100A may display the data—transfer-completed screen. Moreover, when the data transfer is completed, the display device 100A may send a completion notification to the display device 100B. The display device 100B having received the completion notification may display the data-reception-completed screen. Then, the display device 100B may store the data received from the display device 100A. The status of the display devices 100A to 100C and the multifunction device 200 at this time is shown as “status 5B” in FIG. 4.

After the completion of the data transfer from the display device 100A to the display device 100B, the user may disconnect the display device 100B from the display device 100A, and instead connect the display device 100C to the display device 100A. The user may connect the USB host connector 109A of the display device 100A to the USB device connector 100C of the display device 100C by using a USB cable. The display device 100A and the display device 100C may be connected to each other using the USB mass storage device class. When connection of the USB device connector 111C is detected, the display device 100C may display the USB—connected screen. When connection of the USB host connector 109A is detected, the display device 100A may display the confirmation screen. The status of the display devices 100A to 100C and the multifunction device 200 at this time is shown as “status 6B” in FIG. 4.

Subsequently, when the user operates the display device 100A for permitting data transfer, data is transferred from the display device 100A to the display device 100C so as to be stored in the display device 100C. With the display devices 100A to 100C according to an embodiment, the data received from the multifunction device 200 may be stored in the display devices 100A to 100C by simply connecting the display devices 100A to 100C without having to perform operation for designating the data received from the multifunction device 200.

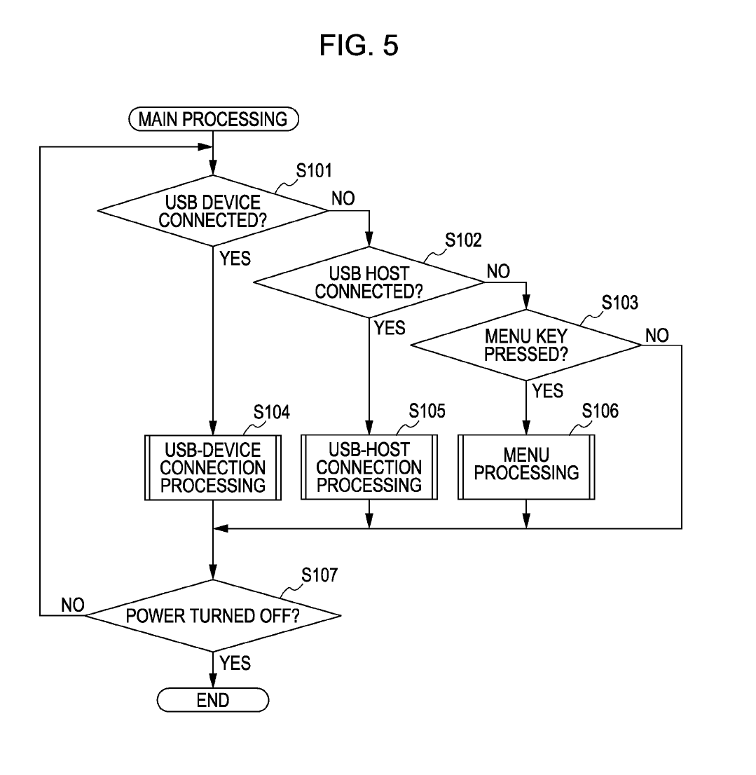

The following flowcharts and associated description describe a detailed operation of the display device 100 that may transfer data on the basis of the aforementioned first operation procedure and the aforementioned second operation procedure. When the power key 151 is pressed, a power source (not shown) may start supplying power to the control unit 101, and the control unit 101 may commence main processing, according to an embodiment of the invention, shown in FIG. 5.

When main processing is commenced, the control unit 101 may determines in Step S101 whether the USB device connector 111 is connected to an external device and communicable with a host-side external device. When it is determined that the USB device connector 111 is communicable with the host-side external device, e.g., “YES” in Step S101, the control unit 101 may perform USB-device connection processing, to be described later, in Step S104.

If the control determines that the USB device connector 111 is not connected to an external device and is not communicable with a host-side external device in Step S101, e.g., “NO” in Step S101, then, in Step S102, the control unit 101 may determine whether the USB host connector 109 is connected to an external device and communicable with a device-side external device. When it is determined that the USB host connector 109 is communicable with the device-side external device, e.g., “YES” in Step S102, the control unit 101 may perform USB-host connection processing, to be described later, in Step S105. If it is determined that the USB host connector 109 is not connected to an external device and is not communicable with a device-side external device, e.g., “NO” in Step S102, the control unit 101 may determine in Step S103 whether the menu key 152 is pressed by the user.

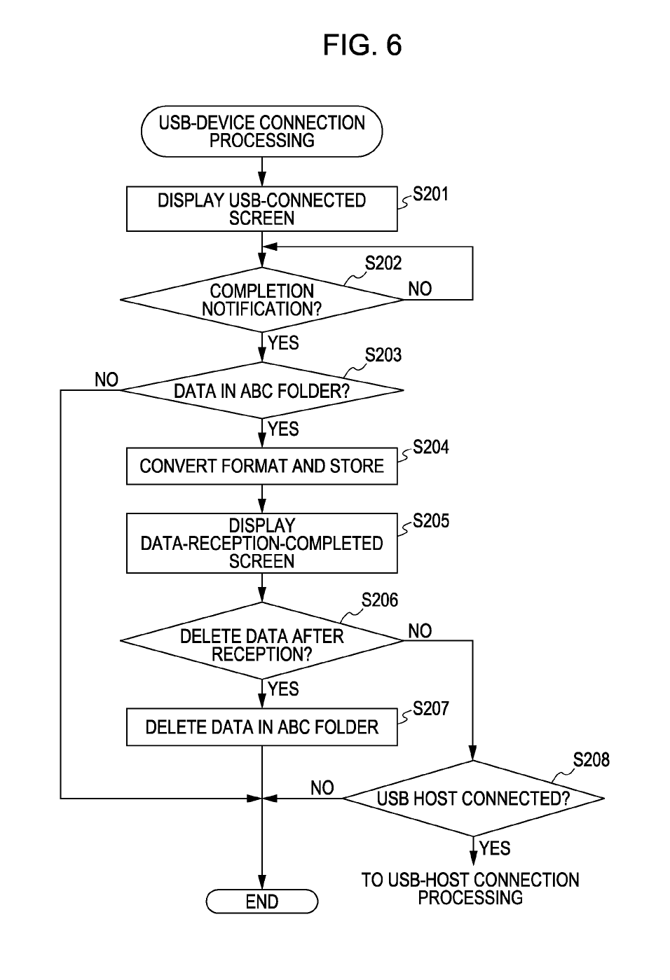

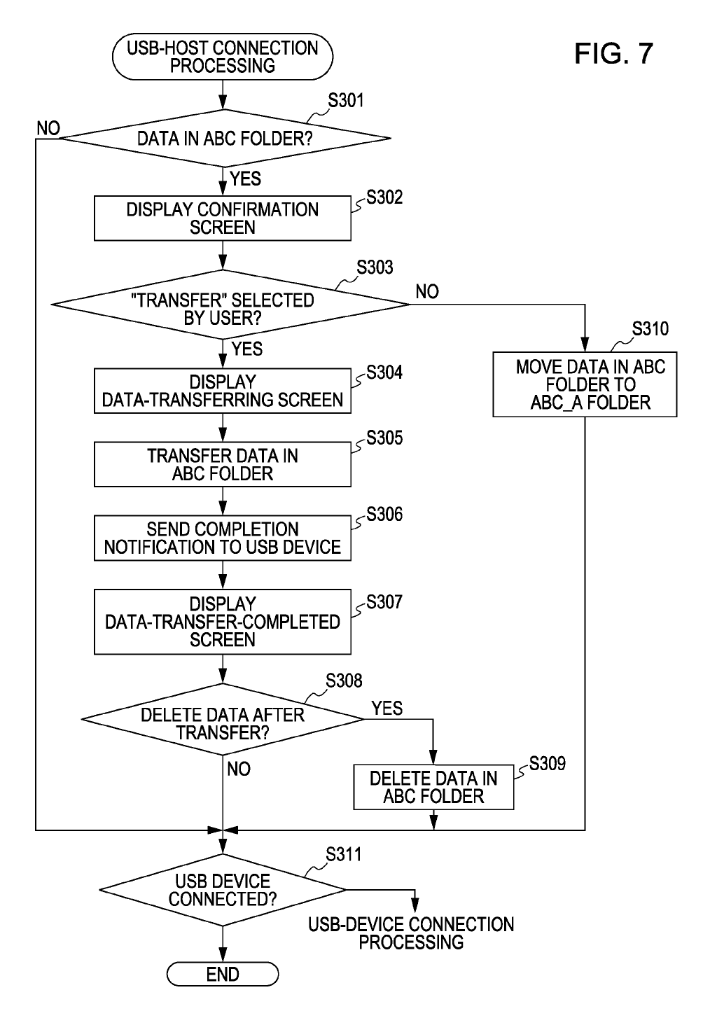

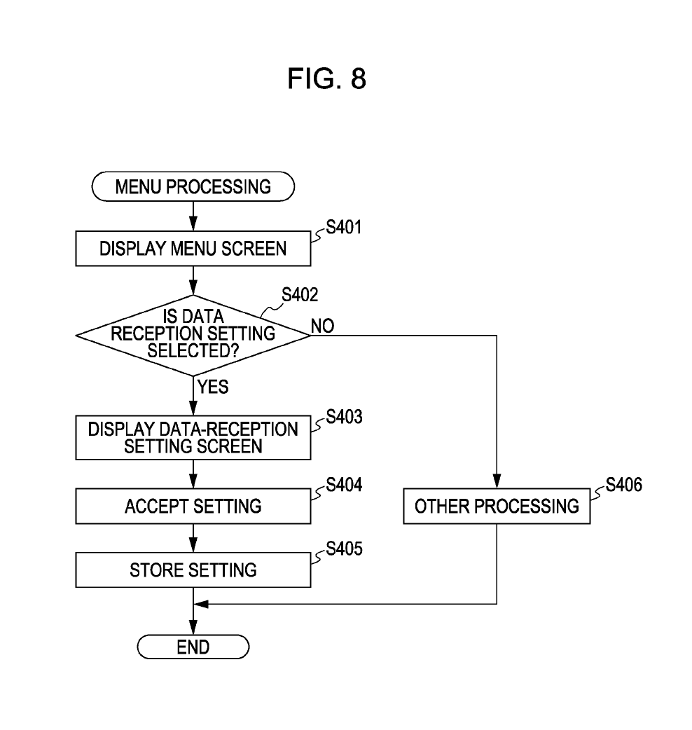

In Step S103, when it is determined that the menu key 152 is pressed by the user, e.g., “YES” in Step S103, the control unit 101 may perform menu processing, to be described later, in Step S106. If it is determined that the menu key 152 is not pressed by the user, e.g., “NO” in Step S103, then if the aforementioned USB-device connection processing is completed in Step S104 (described in more detail with respect to FIG. 6), if the aforementioned USB-host connection processing is completed in Step S105 (described in more detail with respect to FIG. 7), or if the aforementioned menu processing is completed in Step S106 (described in more detail with respect to FIG. 8), the control unit 101 may determine in Step S107 whether or not the power key 151 is pressed. If the power key 151 is pressed, e.g. “YES” in Step S107, the control unit 101 may end the main processing, and the display device 100 may be turned off. If the power key 151 is not pressed, e.g., “NO” in Step S107, the control unit 101 may proceed to step S101 described above to repeat the process shown in FIG. 5.

FIG. 6 describes the USB-device connection processing performed in Step S104 in the aforementioned main processing, according to an embodiment of the invention. When the USB-device connection processing is commenced, then in Step S201, the control unit 101 may control the nonvolatile display panel 103 to display the USB-connected screen indicating a USB-connected state. Then, in Step S202, the control unit 101 may determine whether a completion notification is received from the host-side external device. The control unit 101 may wait until a completion notification is received from the host-side external device, e.g., “NO” in Step S202. After the host-side external device transfers the entire data to be transferred to the display device 100 of the device side and the data is completely stored in the ABC folder in the device-side display device 100, the host-side external device may send a completion notification to the device-side display device 100.

When it is determined that the completion notification has been received, e.g. “YES” in Step S202, then in Step S203, control unit 101 may determine whether there is data in the ABC folder in the memory card 107. If there is no data in the ABC folder in the memory card 107, or if there is no ABC folder in the memory card 107, e.g., “NO” in Step S203, the control unit 101 may proceed to the main processing. When it is determined that there is data in the ABC folder in the memory card 107, e.g., “YES” in Step S203, the control unit 101 may convert the data stored in the ABC folder in the memory card 107 into data in a format that is displayable on the display device 100, and may store the converted data into an area other than the ABC folder in the memory card 107 in Step S204. For example, the converted data may be stored into a folder with a name “DEF” as the area other than the ABC folder. The area other than the ABC folder corresponds to a storage memory area according to the present invention.

Subsequently, in Step S205, the control unit 101 may control the nonvolatile display panel 103 to display the data-reception completed screen. After the data-reception completed screen is displayed, then in Step S206, the control unit 101 may check setting information stored in the internal memory 104 and may determine whether “data deletion after reception” setting information is set. The setting information stored in the internal memory 104 includes one of “no deletion”, “data deletion after reception”, and “data deletion after transfer” settings that may be set in the menu processing, to be described in more detail herein.

If the “data deletion after reception” setting information is stored, e.g., “YES” in Step S206, the control unit 101 may delete the data stored in the ABC folder in the memory card 107 in Step S207 and may return to the aforementioned main processing. If “data deletion after reception” setting information is not stored, e.g., “NO” in Step S206, then in Step S208, control unit 101 may determine whether the USB host connector 109 is connected to an external device and is communicable with a device-side external device. If it is determined that the USB host connector 109 is connected to an external device, e.g., “YES” in Step S208, the control unit 101 may proceed to the USB-host connection processing, to be described in more detail herein. If it is determined that the USB host connector 109 is not connected to an external device, e.g., “NO” in Step S208, the control unit 101 may return to the main processing without proceeding to the USB-host connection processing, to be described later.

FIG. 7 describes the USB-host connection processing performed in Step S105 in the aforementioned main processing, according to an embodiment of the invention. When the USB-host connection processing is commenced, the control unit 101 first may determines in Step S301 whether there is data stored in the ABC folder in the memory card 107. If there is no data stored in the ABC folder, or if there is no ABC folder in the memory card 107, e.g., “NO” in Step S301, the control unit 101 may proceed to Step S311, to be described later.

When it is determined that there is data in the ABC folder, e.g., “YES” in Step S301, then in Step S302, control unit 101 may control the non-volatile display panel 103 to display the confirmation screen. The confirmation screen may be a screen for inquiring the user about whether or not to permit data transfer. The confirmation screen may include a message for confirming whether or not to perform data transfer and two items, i.e., “transfer” and “no transfer” items, at positions corresponding to two specific selecting keys 157.

Subsequently, the control unit 101 may determine in Step S303 whether or not the aforementioned “transfer” item is selected by the user. If control unit 101 determines that the selecting key 157 at the position corresponding to the “no transfer” item is pressed by the user, e.g., “NO” in Step S303, then in Step S310 the control unit 101 may move the data stored in the ABC folder in the memory card 107 to the ABC folder in the memory card 107. Specifically, the data in the ABC folder may be deleted, and the data previously stored in the ABC folder may become stored in the ABC folder.

If control unit 101 determines that the selecting key 157 at the position corresponding to the “transfer” item is pressed by the user, e.g., “YES” in Step S303, then in Step S304, control unit 101 may control the nonvolatile display panel 103 to display the data-transferring screen Subsequently, in Step S305, the control unit 101 may send the data stored in the ABC folder in the memory card 107 to the display device 100 of the device side via the USB host controller 108 and may store the data into the ABC folder in the device-side display device 100. If there is no ABC folder in the memory card 107 of the device-side display device 100, the control unit 101 may create an ABC folder in the memory card 107 of the device-side display device 100 and may store the data therein.

When the data transfer is completed, then in Step S306, control unit 101 may send a completion notification to the device-side display device 100 via the USB host controller 108 and in Step S307, may control the nonvolatile display panel 103 to display the data-transfer-completed screen indicating that the data transfer is completed. Subsequently, the control unit 101 may determine whether or not the “data deletion after transfer” setting information is stored in the internal memory 104 in Step S308. If the “data deletion after transfer” setting information is stored, e.g., “YES” in Step S308, the control unit 101 may delete the data stored in the ABC folder in Step S309. If the “data deletion after transfer” setting information is not stored in the internal memory 104, e.g., “NO” in Step S308, or after the data in the ABC folder is deleted in Step S309, or after the data in the ABC folder is moved to the ABC folder in Step S310, the control unit 101 may determine whether or not the USB device connector 111 is connected to a host-side external device in Step S311.

Thus, when “data deletion after transfer” setting information is stored in the internal memory 104, the data stored in the ABC folder may be deleted immediately after the data is stored in the ABC folder in the device-side display device 100. And, when “no deletion” setting information is stored in the internal memory 104, the data stored in the ABC folder may not be deleted from the ABC folder immediately after the data is stored in the ABC folder in the device-side display device 100.

If the USB device connector 111 is connected to an external device, e.g., “YES” in Step S311, the control unit 101 may proceed to the aforementioned USB-device connection processing. If the USB device connector 111 is not connected to an external device, e.g., “NO” in Step S311, the control unit 101 may proceed to the main processing described previously.

FIG. 8 describes the menu processing performed in Step S106 in the aforementioned main processing, according to an embodiment of the invention. When the menu processing is commenced, the control unit 101 may control the nonvolatile display panel 103 to display the menu screen. The menu screen may include multiple menu items that are displayed at positions corresponding to the respective selecting keys 157. At least one of the multiple menu items may be a “data reception setting” menu item.

Subsequently, in Step S402, the control unit 101 may determine whether one of the selecting keys 157 that is located at the position corresponding to the “data reception setting” menu item is pressed by the user. If it is determined that the selecting key 157 at the position corresponding to the “data reception setting” menu item is pressed, e.g., “YES” in Step S402, then in Step S403, control unit 101 may control the nonvolatile display panel 103 to display a data reception setting screen. The data-reception setting screen may include three kinds of settings, which are “no deletion”, data deletion after reception”, and “data deletion after transfer” settings displayed at positions corresponding to the respective selecting keys 157.

After the data-reception setting screen is displayed, the control unit 101 may accept pressing of a selecting key 157 that corresponds to one of the aforementioned three kinds of settings in Step S404. Then, the setting information corresponding to the pressed selecting key 157 may be stored into the internal memory 104 in Step S405, and the operation may return to the main processing.

If any of the other operation keys 158 is pressed instead of the selecting key 157 located at the position corresponding to the “data reception setting” menu item, e.g., “NO” in Step S402, the control unit 101 may perform processing in response to the pressed operation key 158 in Step S406 and returns to the main processing.

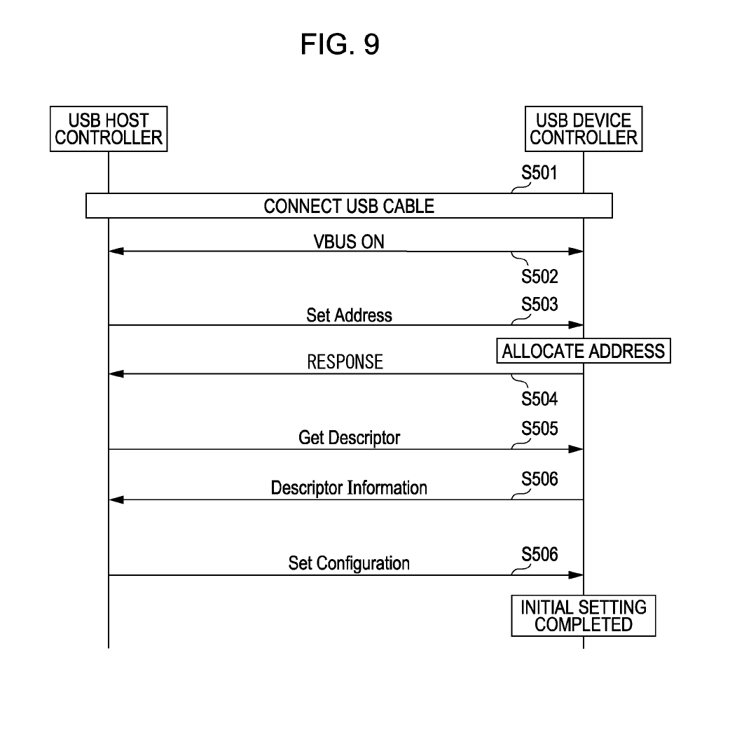

FIG. 9 shows a communication sequence when the USB host connector 109A of the display device 100A and the USB device connector 111B of the display device 100B are connected with each other according to an embodiment of the invention. First, the user may connect the USB host connector 109A of the display device 100A to the USB device connector 111B of the display device 100B by using a USB cable in Step S501. When the USB cable is connected, predetermined voltage may be applied to a VBUS, which may be a power supply line, in Step S502. Subsequently, a USB host controller 108A may allocate an address to a USB device controller 110B connected thereto and may send a “Set Address” USB request to the USB device controller 110B in Step S503. In Step S504, The USB device controller 110B having received the “Set Address” request may store an address designated in the “Set Address” request as its own address and may send a response message indicating that the address setting process is completed to the USB host controller 108A. In Step S505, the USB host controller 108A having received the response message may send a “Get Descriptor” USB request to the USB device controller 110B.

In Step S506, the USB device controller 110B having received the “Get Descriptor” request may send “Descriptor Information”, which is information including the USB class, the product name, and the manufacturer name, to the USB host controller 108A. In this embodiment, the “Descriptor Information” to be sent includes information indicating that the USB class is the storage class. In another embodiment, the descriptor information may include any other type of information.

The USB host controller 108A, having received the “Descriptor Information” as described above, may send a “Set Configuration” USB request to the USB device controller 110B in Step S506. The USB device controller 110B having received the “Set Configuration” request may complete an initial setting process and may send a signal indicating that the connection is established to a control unit 101B of the display device 100B. The control unit 101B having received the signal indicating that the connection is established from the USB device controller 110B may detect that the USB device connector 111B is connected to a host-side external device. Furthermore, the USB host controller 108A sending the “Set Configuration” request subsequently may send a signal indicating that the connection is established to a control unit 101A of the display device 100A. The control unit 101A having received the signal indicating that the connection is established from the USB host controller 108A may detect that the USB host connector 109A is connected to a device-side external device.

With the above-described operation, the display device 100 according to an embodiment can transfer data received via the USB device controller 110 to an external device without the need for the user to designate the data. In an embodiment, the memory card 107 and the memory card interface 106 may correspond to a data storage section according to the invention. The USB device controller 110 may correspond to a first communication section according to the invention. The USB host controller 108 may corresponds to a second communication section according to the invention. The area of the ABC folder in the memory card 107 may correspond to a transfer memory area according to the invention. The area other than the ABC folder in the memory card 107 may correspond to a storage memory area according to the invention. The control unit 101 that stores data into the area other than the ABC folder in Step S204 in the USB-device connection processing may correspond to a particular storage control section according to the invention. The control unit 101 that determines whether the USB device connector 111 is connected in Step S102 in the main processing and in Step S208 in the USB-device connection processing may correspond to a connection detecting section according to the invention.

The control unit 101 that determines whether or not data is stored in the ABC folder in Step S301 in the USB-host connection processing may correspond to a storage determining section according to the invention. The control unit 101 that transfers the data in the ABC folder in Step S305 in the USB-host connection processing may correspond to a transfer control section according to the present invention. The selecting keys 157 may correspond to a setting accepting section according to the invention. The internal memory 104 that stores the setting information in Step S405 in the menu processing may correspond to a setting storage section according to the invention. The “data deletion after transfer” setting may correspond to a first setting according to the invention. The “no deletion” setting may correspond to a second setting according to the invention. The control unit 101 that performs Step S308 and Step S309 in the USB-host connection processing may correspond to a second storage control section according to the invention. The control unit 101 that performs step S206 and Step S207 in the USB-device connection processing may correspond to a third storage control section according to the invention.

The control unit 101 that sends the completion notification in Step S306 in the USB-host connection processing may correspond to a completion notifying section according to the invention. The nonvolatile display panel 103 and the display controller 102 may correspond to a display section according to the invention. The control unit 101 that displays the data-transfer-completed screen in Step S307 in the USB-host connection processing may correspond to an informing section according to the invention. The selecting keys 157 may correspond to a storage accepting section according to the invention. The area of the ABC_A folder in the memory card 107 corresponds to a save memory area according to the invention.

The display device and the program for the display device according to the present invention are not to be limited to the above-described embodiment, and various modifications are permissible so long as they do not depart from the scope of the invention.

In the previously described embodiments, the control unit 101 may wait until a completion notification is received in Step S202 in the USB-device connection processing, and when the completion notification is received, the control unit 101 stores the data in the ABC folder into the area other than the ABC folder. Alternatively, in another embodiment, for example, in Step S202 described above, instead of waiting until receiving a completion notification, the control unit 101 may wait until the USB cable is disconnected from the USB device connector 111, and when the USB cable is disconnected, the control unit 101 may proceed to Step S203. When the USB cable is disconnected, the USB device controller 110 may send a signal indicating that the USB cable has been disconnected to the control unit 101. Thus, the control unit 101 may detect that the USB cable has been disconnected. In this embodiment, the control unit 101 may correspond to a disconnection detecting section according to the present invention.

As yet another embodiment, for example, in Step S202 described above, instead of waiting until receiving a completion notification, the control unit 101 may wait until a certain lapse of time during which communication with an external device is not performed via the USB device controller 110. The control unit 101 may determine whether a predetermined time period has elapsed, during which the communication with an external device is not performed via the USB device controller 110. When the predetermined time period during which communication is not performed elapses, the control unit 101 may proceed to Step S203. In this embodiment, the control unit 101 measures a time period during which communication is not performed by using a timer provided within the CPU 51. The control unit 101 may determine whether or not the predetermined time period has elapsed on the basis of the measured time. The control unit 101 may determine whether communication is performed on the basis of a signal from the USB device controller 110. In this case, the control unit 101 may correspond to an elapsed-time determining section according to the invention.

As still another embodiment, for example, in Step S202 described above, instead of waiting until receiving a completion notification, the control unit 101 may wait until receiving a completion indication notification from the host-side display device 100. When the completion indication notification is received, the control unit 101 may proceed to Step S203. In this embodiment, the host-side display device 100 accepts user's operation that corresponds to a completion indication, and when the operation corresponding to the completion indication is accepted, the host-side display device 100 needs to send the completion indication notification to the device-side display device 100. Therefore, after the data in the ABC folder is transferred in Step S305 in the USB-host connection processing, the device-side display device 100 may detect, for example, whether or not the close key 153 is pressed. When the close key 153 is pressed, the control unit 101 of the host-side display device 100 may send the completion indication notification to the device-side display device 100. In this case, the close key 153 corresponds to a storage-completion-indication accepting section according to the present invention, and the control unit 101 that detects that the close key 153 is pressed and sends the completion indication notification to the device-side display device 100 corresponds to a completion-indication notifying section.

Furthermore, in the previously described embodiments, the data-transfer-completed screen is displayed on the nonvolatile display panel 103 so as to inform that data storage is completed, but other informing methods are also possible in other embodiments. For example, the display device 100 may be provided with an LED that emits light of a predetermined color, and the LED may be configured to emit light in a predetermined pattern. As another embodiment, the display device 100 may be provided with a speaker. In this embodiment, the speaker may be configured to output predetermined sound so as to inform that data storage is completed.

The display device according to the present invention is not limited to a display device, such as an electronic viewer, for displaying image contents, as in the previously described display device 100. For example, the display device may be applicable to any kind of display device equipped with a display section that displays data, such as a digital camera, an audio reproduction device, or a portable telephone.

Furthermore, in the previously described embodiments, the display device 100 may convert the data stored in the ABC folder into data in a format that can be displayed on the nonvolatile display panel 103, and may store the data into the area other than the ABC folder. However, the present invention is not limited to this configuration. The data stored in the ABC folder may be stored into the area other than the ABC folder without being converted so long as the data is displayable on the display device 100.

Furthermore, in the above-described embodiment, in Step S301 in the USB-host connection processing, when there is data in the ABC folder, e.g., “YES” in Step S301, the confirmation screen may be displayed in Step S302. Then, when the user presses the selecting key 157 at the position corresponding to the “transfer” item, e.g., “YES” in Step S303, the data in the ABC folder may be stored into an external device. However, the invention is not limited to this configuration. When there is data in the ABC folder, the data in the ABC folder may be stored into the external device without displaying the confirmation screen.

Furthermore, in the previously described embodiments, although the user can perform “data deletion after reception” setting in the menu processing, the invention is not limited to this configuration. Even when “data deletion after reception” setting is not possible, the data in the ABC folder may be made deletable by allowing the user to operate the display device 100. Alternatively, the data in the ABC folder of the display device 100 may be made deletable via an external device, such as a personal computer.

Furthermore, in the previously described embodiments, the data in the ABC folder may be moved to and saved in the ABC_A folder in Step S310 in the USB-host connection processing; but the invention is not limited to this configuration. The data in the ABC folder may be deleted if the selecting key 157 corresponding to the “transfer” item is not pressed by the user, e.g., “NO” in Step S303). In addition, in the previously described embodiments, although the user can perform “data deletion after transfer” setting in the menu processing, the invention is not limited to this configuration. In the USB-host connection processing described above, when the “data deletion after transfer” setting is stored into the internal memory 104 in Step S308, the data in the ABC folder may be deleted. Alternatively, after storing the data in the ABC folder into an external device, the control unit 101 may be configured to always delete the data in the ABC folder. In this case, the control unit 101 may correspond to a fourth storage control section according to the invention.

Furthermore, in the previously described embodiments, although the display devices 100 may communicate with each other via USB connection, the invention is applicable to display devices that establish communication according to other communication protocols, both software and hardware. Specifically, the display devices may be wire-connected or wirelessly connected to each other. In an embodiment of the invention, the connection between the host side and the device side may be set in advance, to eliminate the user's workload for designating the display device 100 from which data is to be transferred.

Although the display devices 100 may be connected to each other using the USB mass storage class in the previously described embodiments, when one of the display devices 100 is to store data into the ABC folder of an external device, the display device 100 may send the data together with a communication message indicating that the data be stored into the ABC folder, so as to store the data into the ABC folder in the external device.

While the invention has been described in connection with various example structures and illustrative embodiments, it will be understood by those skilled in the art that other variations and modifications of the structures and embodiments described above may be made without departing from the scope of the invention. Other structures and embodiments will be apparent to those skilled in the art from a consideration of the specification or practice of the invention disclosed herein. It is intended that the specification and the described examples are illustrative with the true scope of the invention being defined by the following claims.

What is claimed is:

1. A display device comprising:
a data storage section comprising a transfer memory area and a storage memory area, and configured to store data;
a display section configured to display the data stored in the data storage section;
a first communication section configured to establish communication with a first external device;
a second communication section configured to establish communication with a second external device;
a connection detecting section configured to activate the second communication section when the connection detecting section detects that a connection with the second external device via the second communication section is established;
a storage determining section that determines whether a particular data is stored in the transfer memory area of the data storage section;
a particular storage control section configured to transfer the particular data from the transfer memory area into the storage memory area; and
a transfer control section configured to, when the storage determining section determines that the particular data is stored in the transfer memory area, to transfer the particular data to a transfer memory area of the second external device via the second communication section, when the second communication section is active.

2. The display device according to claim 1, wherein the particular data is data received from the first external device stored in the first communication section.

3. The display device according to claim 1, further comprising:
a setting accepting section that accepts input of a delete setting, wherein when the delete setting is a first setting, the particular data stored in the transfer memory area of the data storage section is deleted immediately after the particular data is stored in the transfer memory area of the second external device, and
when the delete setting is a second setting, the particular data is not deleted from the transfer memory area immediately after the particular data is stored in the transfer memory area of the second device.

4. The display device according to claim 3, further comprising:
a setting storage section configured to store the delete setting accepted by the setting accepting section when the delete setting is inputted; and
a second storage control section configured such that, when the stored delete setting has previously been inputted, when the stored delete setting is the first setting, the particular data stored in the transfer memory area of the data storage section is deleted immediately after the particular data is stored in the transfer memory area of the second external device, and
when the stored delete setting is the second setting, the particular data stored in the transfer memory area of the data storage section is not deleted immediately after the particular data is stored in the transfer memory area of the second external device.

5. The display device according to claim 1, wherein when the delete setting accepted by the setting accepting section is a third setting, the particular data stored in the transfer memory area is deleted immediately after the data is stored in the storage memory area of the particular data storage section by the particular storage control section, and after the particular data is transferred to the transfer memory area of the second external device.

6. The display device according to claim 5, wherein the setting storage section is configured to store the delete setting accepted by the setting accepting section; and the display device further comprises:
a third storage control section configured such that, when the delete setting stored in the third setting storage section is the third setting, the third storage control section deletes the particular data stored in the transfer memory area of the data storage section immediately after the data is stored in the storage memory area of the data storage section, and after the particular data is transferred to the transfer memory area of the second external device.

7. The display device according to claim 1, further comprising a completion notifying section configured to send a completion notification indicating that the storing of the data into the transfer memory area of the second external device by the external device storage control section is completed to the second external device via the second communication section.

8. The display device according to claim 1, wherein the particular storage control section is configured to convert the particular data stored in the transfer memory area of the data storage section into data in a format that is displayable by the display section, and to store the converted particular data into the storage memory area of the data storage section.

9. The display device according to claim 1, further comprising an informing section configured such that, when the storing of the particular data into the transfer memory area of the second external device is completed, the informing section informs that the storing of the particular data is completed by controlling the display section to display a message.

10. The display device according to claim 1, further comprising a storage accepting section configured such that, when the particular data is stored in the transfer memory area, the storage accepting section accepts a storage input regarding whether to store the particular data into the second external device,
wherein when the storage input indicates to store the particular data, the particular data stored in the transfer memory area is transferred into the transfer memory area of the second external device via the second communication section.

11. The display device according to claim 10, wherein the data storage section further comprises a save memory area, and
wherein when the storage input indicates not to store the particular data at the second external device, the particular data stored in the transfer memory area is stored into the save memory area.

12. The display device according to claim 1, further comprising a disconnection detecting section that detects when a connection with the first external device via the first communication section is disconnected,
wherein when the disconnection detecting section detects that the connection with the first external device is disconnected, the particular data stored in the transfer memory area is stored into the storage memory area of the data storage section.

13. The display device according to claim 1, further comprising an elapsed-time determining section configured to determine whether a predetermined time period has elapsed, during which the communication with the first external device via the first communication section has not been performed,
wherein when the elapsed-time determining section determines that the predetermined time period during which the communication has not been performed has elapsed, the particular data stored in the transfer memory area is stored into the storage memory area of the data storage section.

14. The display device according to claim 1, further comprising a fourth storage control section configured to delete the particular data stored in the transfer memory area after the particular data stored in the transfer memory area is stored in the transfer memory area of the second external device.

15. A computer program product stored on a non-transitory computer-readable medium, comprising instructions for causing a computer of a display device to execute the steps of:
determining whether a particular data is stored from a first external device in a transfer memory area of a data storage section;
when the particular data is stored in the transfer memory area, storing the particular data into a storage memory area of the data storage section;
detecting whether a connection with a second external device is established;
determining whether the particular data is stored in the transfer memory area of the data storage section when the connection is detected as being established in the detecting step; and
transferring, when the determining step determines that the particular data is stored in the transfer memory area, the particular data to a transfer memory area of the second external device, when the connection with the second external device is established.

16. A display device comprising:
a data storage section comprising a transfer memory area of the display device and a storage memory area of the display device, and configured to store data;
a display section configured to display the data stored in the data storage section;
a first communication section configured to establish communication with a first external device;
a second communication section configured to establish communication with a second external device comprising an external device storage control section, a transfer memory area of the second external device, and a storage memory area of the second external device;
a connection detecting section configured to activate the second communication section when the connection detecting section detects that a connection with the second external device via the second communication section is established;
a storage determining section that determines whether a particular data is stored in the transfer memory area of the display device;
a particular storage control section configured to transfer the particular data from the transfer memory area of the display device into the storage memory area of the display device; and
a transfer control section configured to, when the storage determining section determines that the particular data is stored in the transfer memory area of the display device, to transfer the particular data to a transfer memory area of the second external device via the second communication section, when the second communication section is active,
wherein when the completion notification is received by an external device storage control section of the second external device, the external device storage control section stores the particular data stored in the transfer memory area of the second external device into the storage memory area of the second external device.

17. The display device according to claim 16, wherein the external device storage control section is configured to convert the particular data stored in the transfer memory area of the second external device into data in a format that is displayable by a display section of the second external device, and to store the converted particular data into the storage memory area of the second external device.

18. The display device according to claim 16, wherein the second external device comprises an indication accepting section configured to accept an indication that the transfer of the particular data from the transfer memory area of the display device into the transfer memory area of the second external device is completed, and the display device further comprises:
a notifying section configured such that, when the accepting section receives the indication of completion, the notifying section sends a completion notification to the second external device via the second communication section,
wherein when the second external device receives the completion indication notification via the first communication section, the particular data stored in the transfer memory area of second external device is stored into the storage memory area of second external device.
